(19) United States
(12) Patent Application Publication
(10) Pub. No.: US 2018/0205054 A1
(43) Pub. Date: Jul. 19, 2018

(54) ELECTRIC POWER STORAGE DEVICE

(71) Applicant: TOYOTA JIDOSHA KABUSHIKI KAISHA, Toyota-shi (JP)

(72) Inventor: Takenori KOBAYASHI, Toyota-shi (JP)

(73) Assignee: TOYOTA JIDOSHA KABUSHIKI KAISHA, Toyota-shi (JP)

(21) Appl. No.: 15/861,102

(22) Filed: Jan. 3, 2018

(30) Foreign Application Priority Data
Jan. 13, 2017 (JP) 2017-004267

(51) Int. Cl. H01M 2/10; B60L 11/18; H01M 2/12; B60K 1/04; H01M 10/613; H01M 10/6563; H01M 10/44

(52) U.S. Cl. CPC H01M 2/1077; B60L 11/1866; B60L 11/1879; H01M 2/12; B60K 2001/005; H01M 10/613; H01M 10/6563; H01M 2/1083; H01M 10/441; B60K 1/04

(57) ABSTRACT

An electric power storage device includes an electric power storage module including a unit electric power storage portion, and a fixing member fixed to the electric power storage module. The electric power storage module includes a first exhaust port configured to discharge gas discharged from the unit electric power storage portion. The fixing member includes a fixing member body fixed to the electric power storage module and a cover member disposed on the fixing member body. The cover member is disposed on a surface of the fixing member body facing the electric power storage module. An exhaust passage, into which the gas discharged from the first exhaust port flows, is formed by the fixing member body and the cover member.

### INCORPORATION BY REFERENCE

The disclosure of Japanese Patent Application No. 2017-004267 filed on Jan. 13, 2017 including the specification, drawings and abstract is incorporated herein by reference in its entirety.

### BACKGROUND

### 1. Technical Field

The present disclosure relates to an electric power storage device.

### 2. Description of Related Art

There have conventionally been proposed various electric power storage devices including a plurality of unit cells and an exhaust mechanism that guides exhaust gas discharged from the unit cells.

For example, an electric power storage device described in Japanese Patent Application Publication No. 2013-114952 (JP 2013-114952 A) includes a plurality of battery blocks, end plates provided at end faces of each battery block, a safety valve duct provided at an upper surface of each battery block, and a gas duct. The battery blocks are arranged in one direction, and each battery block includes a plurality of unit cells. A safety valve is provided at an upper surface of each unit cell.

The safety valve duct is provided to connect the safety valves of the unit cells. An end plate pipe communicating with the safety valve duct is formed in the end plate. The end plate pipe reaches from an upper end face to a lower end face of the end plate.

The safety valve duct is connected to an upper end portion of the end plate pipe, while the gas duct is connected to a lower end portion of the end plate pipe.

In this electric power storage device, when an internal short circuit occurs in the unit cell, gas is ejected from the safety valve of the unit cell. The gas passes through the safety valve duct, the end plate pipe, and the gas duct in this order and is discharged to the outside.

### SUMMARY

As a method of forming the end plate pipe in the end plate in the above-described electric power storage device, boring using a drill or the like may be considered. However, since the distance from the upper end face to the lower end face of the end plate is long, there is a possibility of the occurrence of drill bit breakage, biting of chips, or the like. Therefore, it is difficult to form the end plate pipe by machining the end plate.

In view of this, it may be considered to provide an exhaust duct or the like, which is for discharging gas from the unit cell, separately from the end plate. However, depending on a state of an internal short circuit or the like that occurs in the unit cell, a large amount of gas may be ejected violently from the unit cell, so that the exhaust duct may receive a large load from the gas when the gas enters the exhaust duct. Therefore, there is a possibility that a fixing member for firmly fixing the exhaust duct may be newly required, resulting in increase in size of the electric power storage device.

The present disclosure provides an electric power storage device, having a function to discharge gas from a unit electric power storage portion to the outside, which can be prevented from increasing in size and which is easy to manufacture.

A first aspect of the present disclosure relates to an electric power storage device. The electric power storage device includes an electric power storage module including a unit electric power storage portion, and a fixing member fixed to the electric power storage module. The electric power storage module includes a first exhaust port configured to discharge gas discharged from the unit electric power storage portion. The fixing member includes a fixing member body fixed to the electric power storage module and a cover member disposed on the fixing member body. The fixing member body includes a surface that faces the electric power storage module. The cover member is disposed on the surface. The fixing member body and the cover member define an exhaust passage into which the gas discharged from the first exhaust port flows.

In the first aspect of the present disclosure, the first exhaust port may be open to the exhaust passage.

In the first aspect of the present disclosure, the surface of the fixing member body may include a groove portion defined by an inner surface of the fixing member body. The exhaust passage may be defined by the cover member and the inner surface. The cover member may include a hole portion communicating with the first exhaust port.

In the first aspect of the present disclosure, the cover member may be made of an insulating material.

In the first aspect of the present disclosure, a base of the fixing member body may include a second exhaust port to which the exhaust passage is open.

In the first aspect of the present disclosure, the electric power storage module may include a heat dissipation plate, a negative-electrode bus bar assembly, and a bottom cover. An end face of the heat dissipation plate may include the first exhaust port. The heat dissipation plate may include a first exhaust passage open to the first exhaust port. The negative-electrode bus bar assembly may include a second exhaust passage communicating with the first exhaust passage. A third exhaust passage communicating with the second exhaust passage may be defined by the bottom cover and the negative-electrode bus bar assembly. A bottom surface of the unit electric power storage portion may include a safety valve exposed to the third exhaust passage.

In the first aspect of the present disclosure, the cover member may include a side surface facing the first exhaust port. The side surface may include a hole portion that is open to the first exhaust port. The hole portion may include a bottom portion at a position entering the cover member from the side surface, and the bottom portion may include a thin film portion configured to be melted by the gas discharged from the unit electric power storage portion.

According to the above-described electric power storage device, when gas is ejected from the unit electric power storage portion, the gas is ejected from the exhaust port into the exhaust passage.

The fixing member body is disposed to face the exhaust port and thus the gas mainly impinges on the fixing member body. Since the fixing member body is fixed to the electric power storage module, the fixing member body is prevented from being detached from the electric power storage module.

Even if the gas ejected from the exhaust port impinges on the cover member, the cover member receives a load from the gas in a direction so as to be pressed against the surface of the fixing member body. In this way, even when the gas is ejected from the unit electric power storage portion, the load that is applied in a direction in which the cover member is detached from the fixing member body can be suppressed to be small. Consequently, it is possible to omit a fixing member that is otherwise required for firmly fixing the cover member to the fixing member body. Further, since the exhaust passage can be formed by attaching the cover member to the fixing member body, the assembly is easy.

According to the electric power storage device, the electric power storage device can be prevented from increasing in size and can be easily assembled.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic diagram showing a vehicle 2 equipped with an electric power storage device 1;

FIG. 2 is a perspective view showing a battery unit 4 of the electric power storage device 1;

FIG. 3 is an exploded perspective view showing a battery module 10;

FIG. 4 is a sectional view showing the battery module 10 and a peripheral configuration thereof;

FIG. 5 is a sectional view of the battery unit 4 taken along line V-V shown in FIG. 2;

FIG. 6A is a perspective view showing the battery unit 4 in a state where a fixing plate 14 is detached;

FIG. 6B is a perspective view showing the fixing plate 14 detached from the battery unit 4;

FIG. 7 is an exploded perspective view showing the fixing plate 14;

FIG. 8 is a perspective view showing the fixing plate 14 as viewed from the outer surface 111 side;

FIG. 9 is a sectional view showing an exhaust passage 130 and a peripheral configuration thereof;

FIG. 10 is a sectional view showing a bolt 20 and a peripheral configuration thereof;

and

FIG. 11 is a sectional view showing a modification of a cover member 141.

### DETAILED DESCRIPTION OF EMBODIMENTS

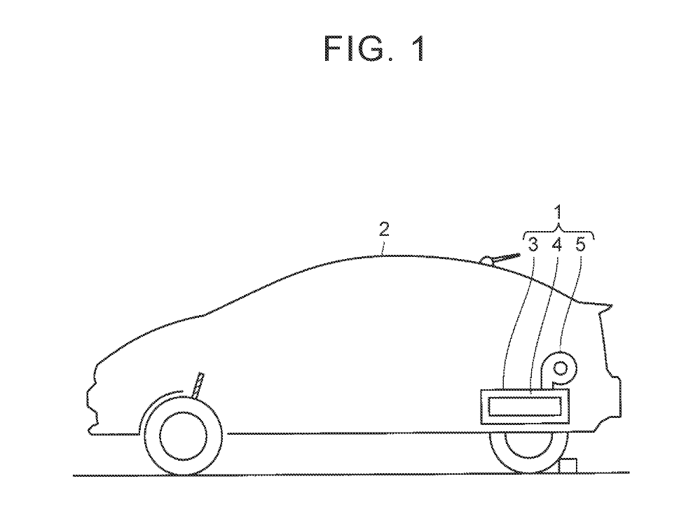

An embodiment will be described with reference to FIGS. 1 to 11. Of the configurations shown in FIGS. 1 to 11, the same or substantially the same configurations will be assigned the same symbols, and description thereof may be omitted.

FIG. 1 is a schematic diagram showing a vehicle 2 equipped with an electric power storage device 1. As shown in FIG. 1, the vehicle 2 includes the electric power storage device 1 disposed in the vehicle 2. The vehicle 2 equipped with the electric power storage device 1 is an electrically driven vehicle such as a hybrid vehicle or an electric vehicle, or a fuel cell vehicle.

The electric power storage device 1 includes a battery case 3, a battery unit 4, and a fan 5. The battery unit 4 is housed in the battery case 3. The fan 5 supplies the air in a passenger compartment into the battery case 3.

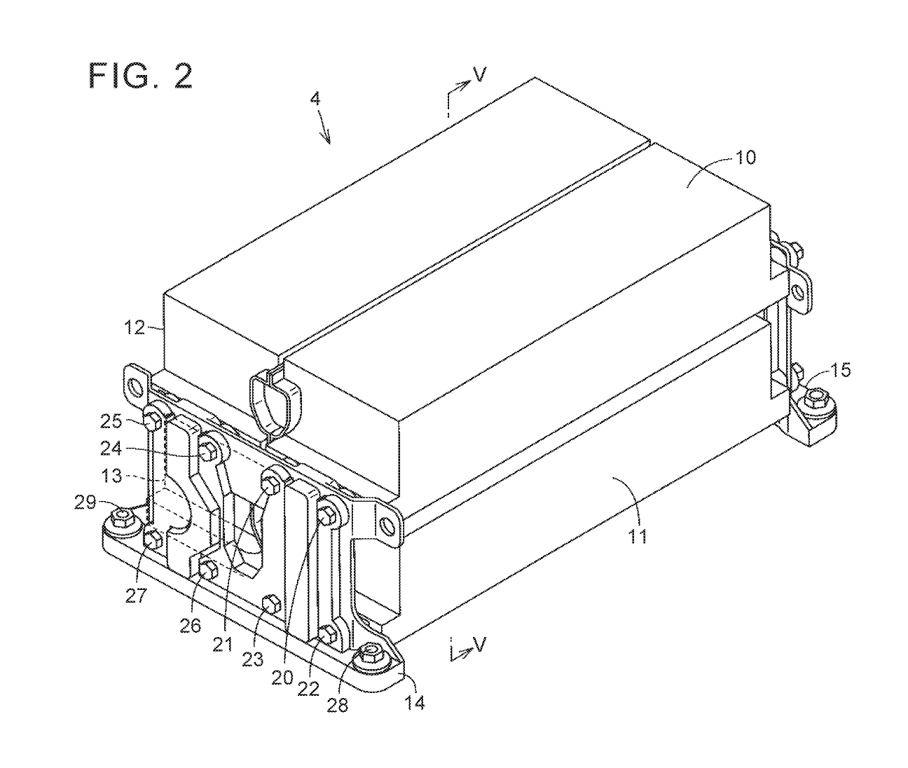

FIG. 2 is a perspective view showing the battery unit 4 of the electric power storage device 1. As shown in FIG. 2, the electric power storage device 1 includes a plurality of battery modules 10 to 13 and fixing plates 14 and 15 (fixing members) respectively provided at both ends of the electric power storage device 1. The electric power storage device 1 has a generally rectangular parallelepiped shape and is disposed longitudinally in a width direction of the vehicle 2.

The fixing plate 14 is provided at a first end in a longitudinal direction of the electric power storage device 1, while the fixing plate 15 is provided at a second end of the electric power storage device 1.

The fixing plate 14 is fixed to the battery modules 10 to 13 by a plurality of bolts 20 to 27, so that the battery modules 10 to 13 are fixed to each other by the fixing plate 14. The fixing plate 14 is fixed to a bottom surface of the battery case 3 by bolts 28 and 29. Like the fixing plate 14, the fixing plate 15 is also fixed to the battery modules 10 to 13 and the bottom surface of the battery case 3.

Accordingly, the battery modules 10 to 13 are coupled to each other and fixed to the bottom surface of the battery case 3 via the fixing plates 14 and 15.

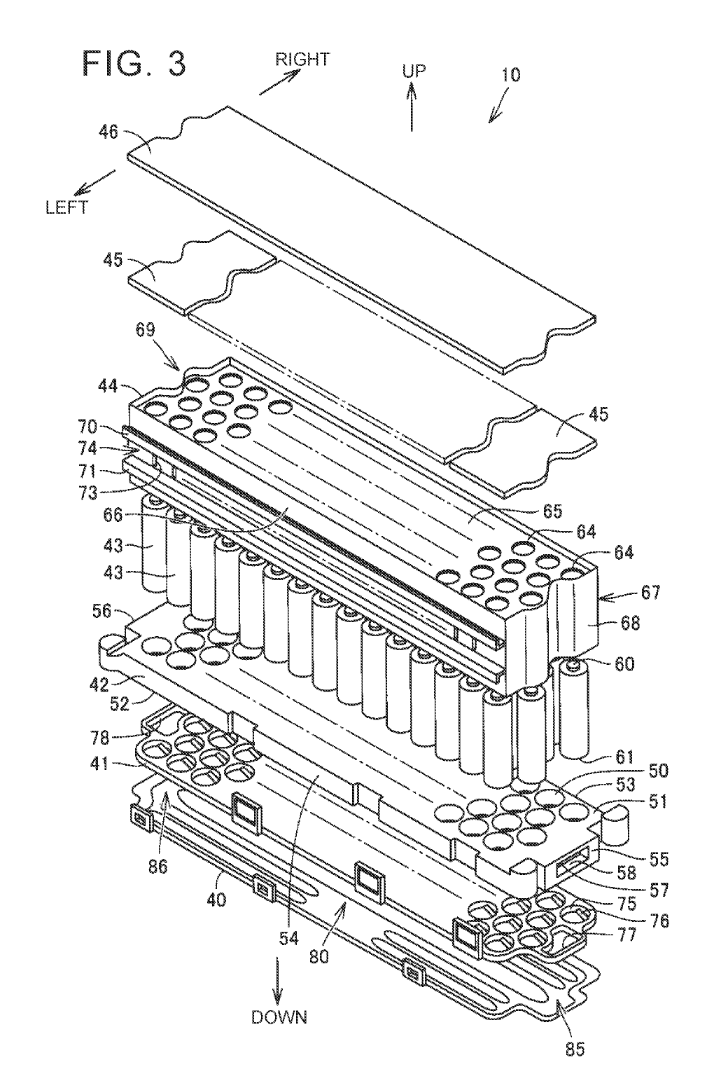

FIG. 3 is an exploded perspective view showing the battery module 10. As shown in FIG. 3, the battery module 10 includes a bottom cover 40, a negative-electrode bus bar assembly 41, a heat dissipation plate 42, a plurality of cylindrical cells 43, a resin cover 44, a plurality of positive-electrode bus bars 45, and a top cover 46.

The heat dissipation plate 42 is a plate-like member made of a metal. The heat dissipation plate 42 is formed with a plurality of through-holes 50 extending in a thickness direction of the heat dissipation plate 42. The through-holes 50 are arranged in an array.

The heat dissipation plate 42 has an upper surface 51, a lower surface 52, a pair of side surfaces 53 and 54, and a pair of end faces 55 and 56. Each through-hole 50 reaches from the upper surface 51 to the lower surface 52.

Exhaust passages (first exhaust passages) and exhaust ports (first exhaust ports) are formed on the end face 55 side and the end face 56 side of the heat dissipation plate 42. While an exhaust passage 57 and an exhaust port 58 formed on the end face 55 side are shown in FIG. 3, the same exhaust passage and the same exhaust port are formed also on the end face 56 side.

The exhaust passage 57 extends to enter the heat dissipation plate 42 from the lower surface 52 and then extends toward the end face 55. Then, the exhaust passage 57 communicates with the exhaust port 58 formed at the end face 55.

The cylindrical cell 43 is a chargeable and dischargeable secondary battery. The cylindrical cell 43 is, for example, a nickel-hydrogen battery or a lithium-ion battery. The cylindrical cell 43 is formed at its upper end with a positive electrode 60 and at its lower end with a negative electrode 61. While the cylindrical cell is employed as a unit electric power storage portion in this embodiment, a prismatic battery or a capacitor may alternatively be employed.

The cylindrical cells 43 are respectively inserted into the through-holes 50 formed in the heat dissipation plate 42. The positive electrodes 60 of the cylindrical cells 43 are located above the upper surface 51 of the heat dissipation plate 42, while the negative electrodes 61 of the cylindrical cells 43 are located below the lower surface 52 of the heat dissipation plate 42.

A resin or the like is provided between inner peripheral surfaces of the through-holes 50 of the heat dissipation plate 42 and outer peripheral surfaces of the cylindrical cells 43, so that the cylindrical cells 43 are fixed to the heat dissipation plate 42.

The resin cover 44 is disposed on the upper surface 51 of the heat dissipation plate 42. The resin cover 44 is formed to be open downward and has a top plate 65, a pair of side walls 66 and 67, and a pair of end walls 68 and 69.

Lower end portions of the side walls 66 and 67 and lower end portions of the end walls 68 and 69 are disposed on the upper surface 51 of the heat dissipation plate 42.

The side wall 66 is formed with an upper flange 70 and a lower flange 71. The upper flange 70 and the lower flange 71 are formed to extend from the end wall 68 to the end wall 69 and are provided at an interval in a vertical direction.

The side wall 66 is formed with a plurality of ventilation openings 73 at a portion located between the upper flange 70 and the lower flange 71. Likewise, the side wall 67 is formed with a plurality of ventilation openings.

The upper flange 70 of the battery module 10 is in close contact with an upper flange 70 of the battery module 12 disposed adjacent to the battery module 10, while the lower flange 71 of the battery module 10 is in close contact with a lower flange 71 of the battery module 12. Consequently, a ventilation passage 74 is formed between the upper flanges 70 and the lower flanges 71. The ventilation passage 74 communicates with the fan 5. The top plate 65 is formed with a plurality of holes 64 into which the cylindrical cells 43 are respectively inserted.

The positive-electrode bus bars 45 are provided above the top plate 65 of the resin cover 44. Each positive-electrode bus bar 45 connects the positive electrodes 60 of, for example, about 10 cylindrical cells 43 to each other.

The top cover 46 is disposed above the positive-electrode bus bars 45. The top cover 46 is made of an insulating material such as a resin.

The negative-electrode bus bar assembly 41 is disposed on the lower surface 52 side of the heat dissipation plate 42. The negative-electrode bus bar assembly 41 includes a plurality of negative-electrode bus bars (not shown) and a resin mold integrating the negative-electrode bus bars. The outer shape of the negative-electrode bus bar is similar to that of the positive-electrode bus bar 45. The negative-electrode bus bar assembly 41 (negative-electrode bus bars) is formed with a plurality of holes 75. Each hole 75 includes a terminal 76 that is formed to protrude from an inner peripheral surface of the hole 75. The negative electrode 61 of the cylindrical cell 43 is connected to the terminal 76.

Each negative-electrode bus bar is configured to connect to each other the negative electrodes 61 of the same cylindrical cells 43 as those of the corresponding positive-electrode bus bar 45.

Therefore, the cylindrical cells 43 are electrically connected in parallel to each other by each negative-electrode bus bar and the corresponding positive-electrode bus bar 45. The positive-electrode bus bars 45 and the negative-electrode bus bars are electrically connected to each other such that the sets each including the cylindrical cells 43 connected in parallel to each other by the negative-electrode bus bar and the positive-electrode bus bar 45 are connected in series to each other.

The negative-electrode bus bar assembly 41 is formed at its first end with an exhaust passage 77 (second exhaust passage) and at its second end with an exhaust passage 78 (second exhaust passage). The exhaust passages 77 and 78 are each formed to pass through the negative-electrode bus bar assembly 41 in a thickness direction.

The exhaust passage 77 communicates with the exhaust passage 57 formed in the heat dissipation plate 42. The exhaust passage 78 communicates with the exhaust passage formed on the end face 56 side of the heat dissipation plate 42.

The bottom cover 40 is disposed on the lower surface side of the negative-electrode bus bar assembly 41. The bottom cover 40 is made of a metal such as aluminum.

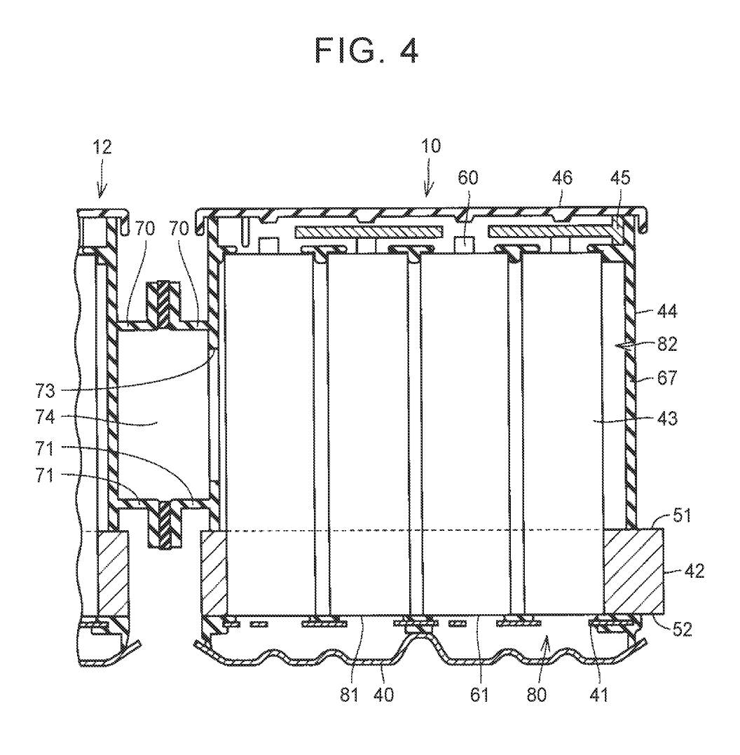

FIG. 4 is a sectional view showing the battery module 10 and a peripheral configuration thereof. As shown in FIG. 4, an exhaust passage 80 (third exhaust passage) is defined by the bottom cover 40 and the negative-electrode bus bar assembly 41. A safety valve 81 is formed at a bottom surface of the cylindrical cell 43 and exposed to the exhaust passage 80.

In FIGS. 3 and 4, the exhaust passage 80 communicates with the exhaust passage 77 and the exhaust passage 78, and an exhaust passage 85 is formed by the exhaust passage 80, the exhaust passage 77, and the exhaust passage 57.

Likewise, an exhaust passage 86 is formed by the exhaust passage 80, the exhaust passage 78, and the exhaust passage formed on the end face 56 side.

In FIG. 4, a ventilation chamber 82 is formed by the resin cover 44 and the heat dissipation plate 42, and the ventilation chamber 82 and the ventilation passage 74 communicate with each other via the ventilation openings 73.

The fan 5 supplies cooling air to the ventilation passage 74, and the cooling air flowing in the ventilation passage 74 enters the ventilation chamber 82 via the ventilation openings 73.

The cylindrical cells 43 are cooled by the cooling air that has entered the ventilation chamber 82, and then the cooling air that has cooled the ventilation chamber 82 is discharged from the ventilation openings formed in the side wall 67.

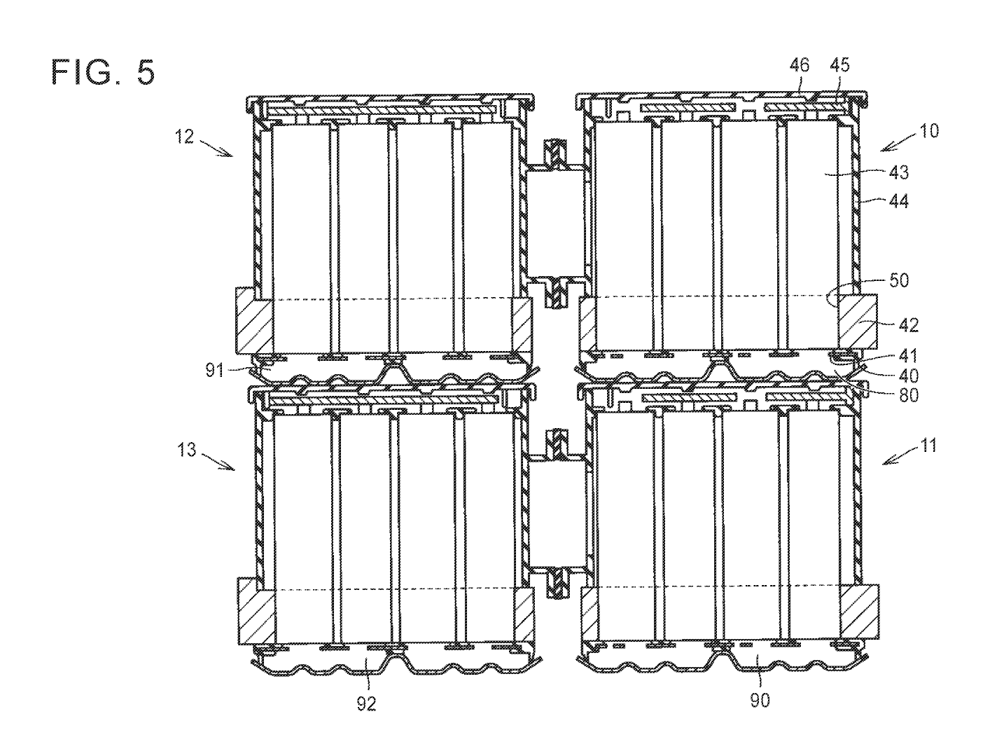

The battery modules 11, 12, and 13 are configured in the same manner as the battery module 10. FIG. 5 is a sectional view of the battery unit 4 taken along line V-V shown in FIG. 2. As shown in FIG. 5, the battery modules 11, 12, and 13 are respectively formed with exhaust passages 90, 91, and 92.

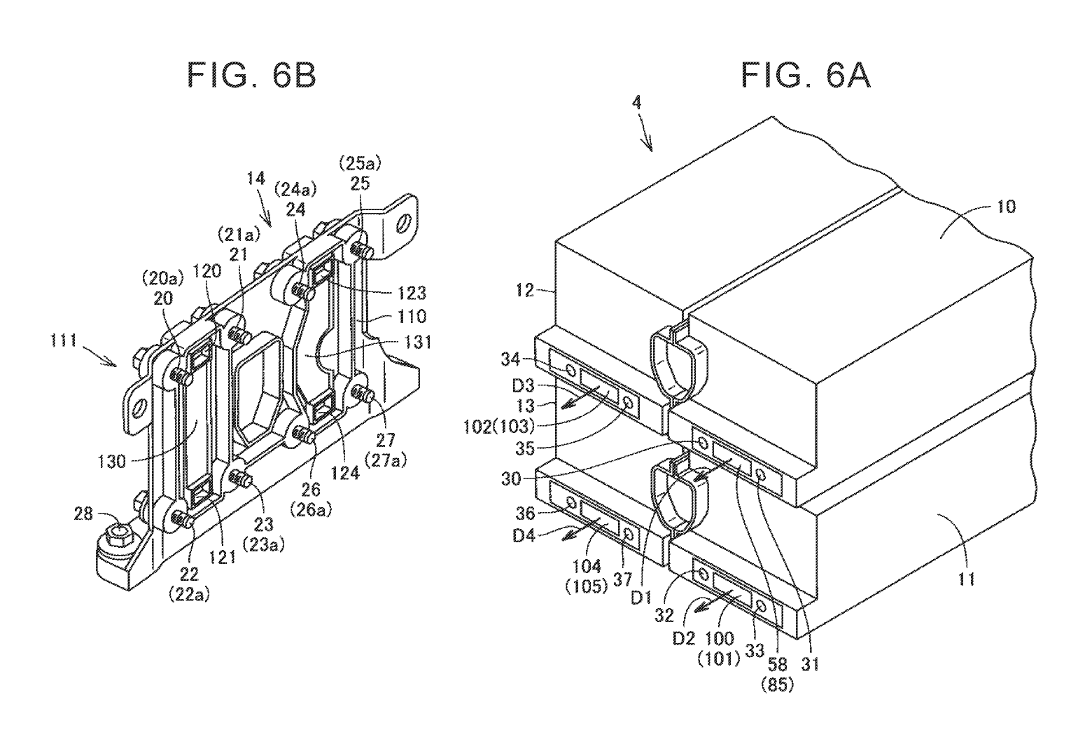

FIG. 6A is a perspective view showing the battery unit 4 in a state where the fixing plate 14 is detached. FIG. 6B is a perspective view showing the fixing plate 14 detached from the battery unit 4. As shown in FIG. 6A, the exhaust port 58 and bolt holes 30 and 31 are formed at one end face of the battery module 10.

An exhaust port 100 and bolt holes 32 and 33 are formed at one end face of the battery module 11. An exhaust passage 101 communicates with the exhaust port 100. The exhaust passage 101 includes the exhaust passage 90 shown in FIG. 5.

An exhaust port 102 and bolt holes 34 and 35 are formed at one end face of the battery module 12. An exhaust passage 103 communicates with the exhaust port 102. The exhaust passage 103 includes the exhaust passage 91 shown in FIG. 5.

An exhaust port 104 and bolt holes 36 and 37 are formed at one end face of the battery module 13. An exhaust passage 105 communicates with the exhaust port 104. The exhaust passage 105 includes the exhaust passage 92 shown in FIG. 5.

The bolts 20 to 27 of the fixing plate 14 are respectively inserted into the bolt holes 30 to 37. The bolt holes 30 to 37 are formed on their inner surfaces with threaded portions into which threaded shafts 20a to 27a of the bolts 20 to 27 are respectively screwed, so that the fixing plate 14 is fixed to one end of the battery modules 10, 11, 12, and 13.

When, for example, an internal short circuit or the like occurs in the cylindrical cell 43 in the battery module 10, gas from the cylindrical cell 43 passes through the exhaust passage 85 and is ejected from the exhaust port 58.

In this event, the gas is ejected from the exhaust port 58 in an ejection direction D1. Likewise, when an internal short circuit or the like occurs in the cylindrical cell in the battery module 11, 12, or 13, gas passes through the exhaust passage 101, 103, or 105 and is ejected from the exhaust port 100, 102, or 104 in an ejection direction D2, D3, or D4.

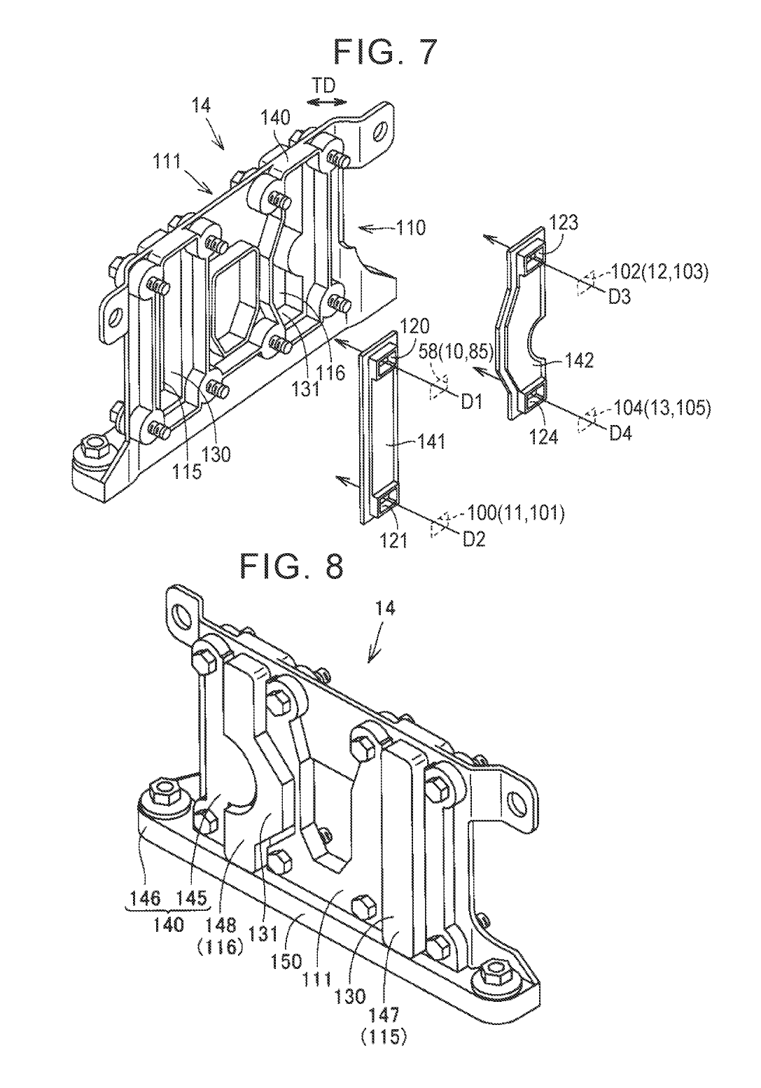

FIG. 7 is an exploded perspective view showing the fixing plate 14. As shown in FIG. 7, the fixing plate 14 includes a plate-like fixing member body 140 and cover members 141 and 142.

The fixing member body 140 is disposed in front of the exhaust ports 58, 100, 102, and 104 in the ejection directions D1, D2, D3, and D4 and formed in a plate-like shape. The fixing member body 140 has an opposing surface 110 (surface) facing the battery modules 10, 11, 12, and 13 and an outer surface 111 located on the outer side of the battery unit 4. The opposing surface 110 and the outer surface 111 are arranged in a thickness direction TD of the fixing member body 140.

The opposing surface 110 of the fixing member body 140 is formed with a groove portion 115 and a groove portion 116. The groove portion 115 and the groove portion 116 are each formed to extend from the upper end face side to the lower end face side of the fixing member body 140. The groove portion 115 and a groove portion 116 are defined by inner surfaces of the fixing member body 140.

The cover members 141 and 142 are formed in a plate-like shape and attached to the opposing surface 110.

The cover member 141 is formed with an exhaust port 120 at a portion located in front of the exhaust port 58 in the ejection direction D1 and with an exhaust port 121 at a portion located in front of the exhaust port 100 in the ejection direction D2. The exhaust port 120 is formed on the upper end side of the cover member 141, while the exhaust port 121 is formed on the lower end side of the cover member 141.

The cover member 141 is disposed to close an opening of the groove portion 115, so that an exhaust passage 130 is defined in the fixing plate 14 by the cover member 141 and the inner surfaces of the groove portion 115.

When the fixing plate 14 is fixed to the battery modules 10 to 13, the exhaust port 120 (hole portion) of the cover member 141 and the exhaust port 58 of the battery module 10 communicate with each other. Consequently, the exhaust passage 85 of the battery module 10 and the exhaust passage 130 of the fixing plate 14 communicate with each other via the exhaust ports 58 and 120.

Likewise, the exhaust port 121 of the cover member 141 and the exhaust port 100 of the battery module 11 communicate with each other, so that the exhaust passage 101 and the exhaust passage 130 communicate with each other via the exhaust ports 100 and 121.

Further, exhaust ports 123 and 124 of the cover member 142 and the exhaust ports 102 and 104 communicate with each other, so that an exhaust passage 131 of the fixing plate 14 and the exhaust passages 103 and 105 communicate with each other.

FIG. 8 is a perspective view showing the fixing plate 14 as viewed from the outer surface 111 side. As shown in FIG. 8, the fixing member body 140 includes a base 146 fixed to the bottom surface of the battery case 3 and a plate-like plate 145 formed on an upper surface of the base 146.

A protruding portion 147 and a protruding portion 148 are formed on a surface on the outer surface 111 side of the plate 145. The protruding portions 147 and 148 are formed to bulge outward from the outer surface 111, so that the groove portions 115 and 116 are respectively formed by the protruding portions 147 and 148.

The base 146 is formed with an exhaust port 150 (second exhaust port). The exhaust port 150 is formed at the outer surface 111 of the fixing member body 140. A duct (not shown) is connected to the exhaust port 150, and the duct communicates with the outside of the vehicle 2. The exhaust port 150 communicates with the exhaust passage 130 and the exhaust passage 131. The fixing plate 15 shown in FIG. 2 is configured in the same manner as the fixing plate 14.

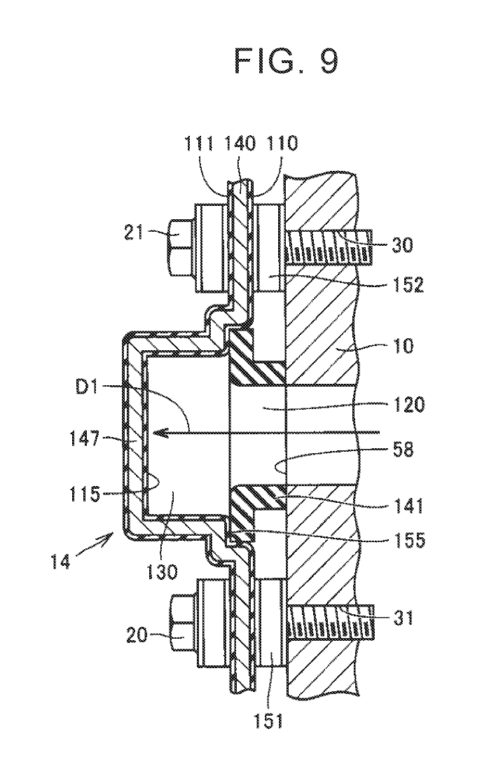

FIG. 9 is a sectional view showing the exhaust passage 130 and a peripheral configuration thereof. As shown in FIG. 9, when gas is ejected from the exhaust port 58 of the battery module 10, the gas passes through the exhaust port 120 and impinges on the inner surface of the groove portion 115.

Then, the gas that has entered the exhaust passage 130 passes through the exhaust port 150 shown in FIG. 8 and is discharged to the outside of the electric power storage device 1. The duct (not shown) is connected to the exhaust port 150, so that the gas passes through the duct and is discharged to the outside of the vehicle 2.

Herein, when the gas ejected from the exhaust port 58 of the battery module 10 impinges on the inner surface of the groove portion 115, the fixing member body 140 receives a load in a direction away from the battery module 10.

On the other hand, the fixing plate 14 is provided primarily for coupling the battery modules 10, 11, 12, and 13 to each other and for fixing the coupled battery modules 10, 11, 12, and 13 to the bottom surface of the battery case 3.

Since the battery modules 10, 11, 12, and 13 are heavy in weight, when a centrifugal force or the like is applied during the travel of the vehicle 2, a large load is applied to the fixing plate 14.

Therefore, the fastening force by the fixing members such as the bolt 20 is large, so that the fixing member body 140 is firmly fixed to the battery module 10 and so on.

Since, in this way, the fixing member body 140 is firmly fixed to the battery module 10 and so on, even when the load is applied from the gas ejected from the exhaust port 58 of the battery module 10, the fixing member body 140 is prevented from being detached from the battery module 10 and so on.

In this way, even when gas is ejected from the cylindrical cell 43 in the battery module 10, the gas can be satisfactorily discharged to the outside of the vehicle 2, and further, since it is not necessary to newly provide a fixing member for fixing the fixing member body 140, an increase in size of the electric power storage device 1 is prevented.

In FIG. 9, a stepped portion 155 is formed along the opening edge of the groove portion 115. The stepped portion 155 is formed in an annular shape. The cover member 141 is fitted to the stepped portion 155 and is fixed to the stepped portion 155 with an adhesive or the like. In this way, since the exhaust passage 130 is formed by disposing the cover member 141 in the opening of the groove portion 115, the surface area of the groove portion 115 located in the exhaust passage 130 is greater than that of the cover member 141. Therefore, the gas that has entered the exhaust passage 130 mainly hits on the fixing member body 140. As a result, hitting of the gas on the cover member 141 is suppressed and thus the load applied to the cover member 141 is suppressed to be small. Consequently, even when the cover member 141 is fixed to the fixing member body 140 with the adhesive or the like, the cover member 141 is prevented from being misaligned.

Likewise, even when gas is ejected from the exhaust port of the battery module 11, 12, or 13, the gas can be discharged to the outside of the vehicle 2, and further, the fixing member body 140 can be prevented from coming off the battery module 11, 12, or 13.

Herein, assuming that gas ejected from the exhaust port 58 of the battery module 10 impinges on the cover member 141, the cover member 141 receives a load from the gas in a direction so as to be pressed against the opposing surface 110 of the fixing member body 140. Therefore, even when the gas impinges on the cover member 141, the load is unlikely to be applied in a direction in which the cover member 141 is detached from the fixing member body 140. Accordingly, the cover member 141 can be fixed to the fixing member body 140 with the adhesive or the like, so that it is possible to prevent an increase in size of the electric power storage device 1 and to simplify the assembly process of the electric power storage device 1. Like the cover member 141, the cover member 142 can also be fixed to the fixing member body 140 with the adhesive or the like.

Herein, the cover member 141 is made of an insulating material such as a resin. Therefore, the battery module 10 and the fixing member body 140 are prevented from being electrically connected to each other via the cover member 141.

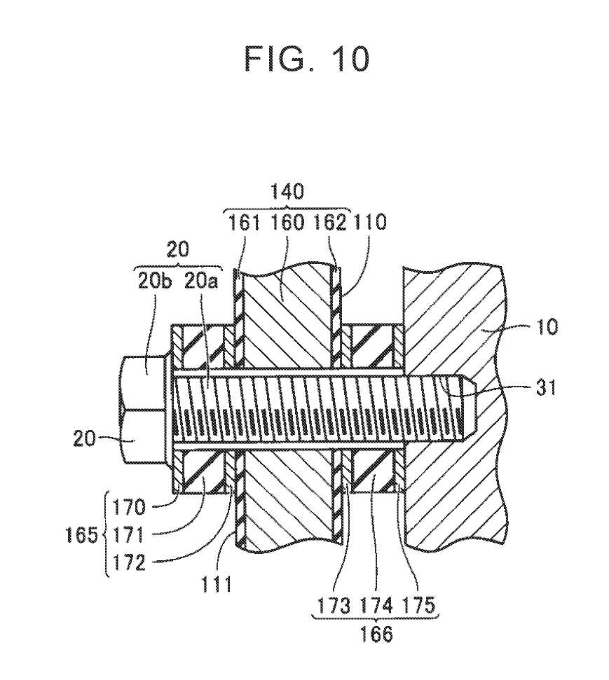

FIG. 10 is a sectional view showing the bolt 20 and a peripheral configuration thereof. As shown in FIG. 10, the bolt 20 has a head portion 20b disposed on the outer surface 111 side of the fixing member body 140 and the threaded shaft 20a connected to the head portion 20b. A leading end portion of the threaded shaft 20a is screwed into the bolt hole 31.

An interposition member 165 is disposed between the head portion 20b and the outer surface 111 of the fixing member body 140. Further, an interposition member 166 is disposed between the opposing surface 110 of the fixing member body 140 and the battery module 10.

The interposition member 165 includes a metal plate 170, an insulating member 171, and a metal plate 172, and the insulating member 171 is disposed between the metal plate 170 and the metal plate 172. Therefore, the insulation between the head portion 20b and the fixing member body 140 is ensured.

Likewise, the interposition member 166 includes a metal plate 173, an insulating member 174, and a metal plate 175, and the insulating member 174 is disposed between the metal plate 173 and the metal plate 175.

Therefore, the fixing member body 140 and the battery module 10 are prevented from directly contacting each other and prevented from being electrically connected to each other.

Herein, the interposition member 165, the fixing member body 140, and the interposition member 166 are respectively formed with through-holes into which the threaded shaft 20a is inserted. The inner diameter of each through-hole is greater than a diameter of the threaded shaft 20a such that the threaded shaft 20a is prevented from contacting an inner peripheral surface of each through-hole. The fixing member body 140 includes a metal plate 160 and insulating coating films 161 and 162 covering surfaces of the metal plate 160.

In this way, the insulation between the battery module 10 and the fixing member body 140 (the metal plate 160) is ensured, and further, the insulation between the bolt 20 fixed to the battery module 10 and the fixing member body 140 (the metal plate 160) is also ensured. Likewise, with respect to the other bolts 21 to 27, interposition members are disposed between the fixing member body 140 and head portions of the bolts 21 to 27 and between the fixing member body 140 and the battery modules 10, 11, 12, and 13.

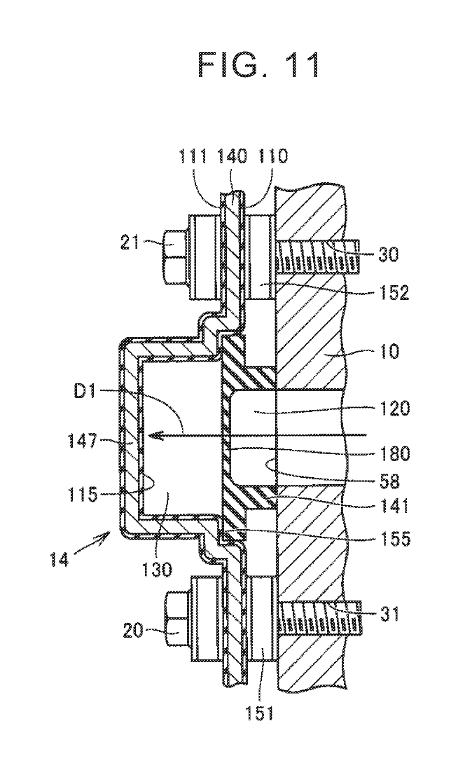

FIG. 11 is a sectional view showing a modification of the cover member 141. In the cover member 141 shown in FIG. 11, a thin film portion 180 (film portion) is formed between the exhaust port 58 and the exhaust passage 130. That is, the cover member 141 has a hole portion that is open at a side surface facing the exhaust port 58, and the hole portion includes a bottom portion at a position entering the cover member 141 from the side surface. The bottom portion is formed by the thin film portion 180. Therefore, in a normal state, the exhaust passage 130 and the exhaust port 58 of the battery module 10 do not communicate with each other.

Accordingly, it is possible to prevent the foreign matter outside the vehicle 2 from entering the battery module 10 via the exhaust passage 130.

Then, when an internal short circuit occurs in the cylindrical cell 43 in the battery module 10 so that gas is ejected from the exhaust port 58 of the battery module 10 and impinges on the thin film portion 180, the thin film portion 180 is melted. This is because when gas is ejected from the cylindrical cell 43 due to an internal short circuit or the like, the temperature of the gas is very high. Then, when the thin film portion 180 is melted, the gas from the cylindrical cell 43 enters the exhaust passage 130, flows in the exhaust passage 130, and is discharged to the outside of the vehicle 2.

As described above, in the present disclosure, the exhaust passage 130 and the exhaust port 58 of the battery module 10 being in communication with each other is not an essential configuration in the normal state.

In the above-described embodiment, the cover member 141 is fixed to the fixing member body 140 with the adhesive or the like, but the cover member 141 is not necessarily fixed to the fixing member body 140. For example, the cover member 141 may be fixed to the battery module 10 and may be pressed against the fixing member body 140 by the fastening force of the bolt 20 and so on. In the above-described embodiment, the electric power storage device 1 including the plurality of battery modules 10 to 13 has been described, but the number of battery modules may alternatively be one. When the number of battery modules is one, the fixing plates 14 and 15 are fixed to the end faces of the single battery module and further fixed to the bottom surface of the battery case 3, so that the single battery module is fixed to the battery case 3 by the fixing plates 14 and 15.

Further, while the fixing plates 14 and 15 are disposed at the end faces of the battery modules, the fixing plates 14 and 15 are not necessarily disposed at the end faces of the battery modules. That is, since the fixing plates 14 and 15 are members for fixing the battery modules to the battery case 3, the fixing plates 14 and 15 may be disposed at any position such as near the middle of the battery modules.

The embodiment disclosed herein is for illustrative purposes only and should not be construed as being limitative in any aspect. In the embodiment disclosed herein, the exhaust passage is formed by providing the groove portion to the fixing member body, but an exhaust passage may alternatively be formed by providing a groove portion to the cover member. The scope of the present disclosure is defined by the claims, not by the description described above, and is intended to include all changes within the meaning and range of equivalents of the claims.

What is claimed is:

1. An electric power storage device comprising:
an electric power storage module including a unit electric power storage portion, the electric power storage module including a first exhaust port configured to discharge gas discharged from the unit electric power storage portion; and
a fixing member fixed to the electric power storage module, the fixing member including a fixing member body fixed to the electric power storage module and a cover member disposed on the fixing member body, the fixing member body including a surface that faces the electric power storage module, the cover member disposed on the surface, the fixing member body and the cover member defining an exhaust passage into which the gas discharged from the first exhaust port flows.

2. The electric power storage device according to claim 1, wherein
the first exhaust port is open to the exhaust passage.

3. The electric power storage device according to claim 1, wherein
the surface of the fixing member body includes a groove portion defined by an inner surface of the fixing member body, the exhaust passage is defined by the cover member and the inner surface, and the cover member includes a hole portion communicating with the first exhaust port.

4. The electric power storage device according to claim 1, wherein
the cover member is made of an insulating material.

5. The electric power storage device according to claim 1, wherein
a base of the fixing member body includes a second exhaust port to which the exhaust passage is open.

6. The electric power storage device according to claim 1, wherein
the electric power storage module includes a heat dissipation plate, a negative-electrode bus bar assembly, and a bottom cover, an end face of the heat dissipation plate includes the first exhaust port, the heat dissipation plate includes a first exhaust passage open to the first exhaust port, the negative-electrode bus bar assembly includes a second exhaust passage communicating with the first exhaust passage, a third exhaust passage communicating with the second exhaust passage is defined by the bottom cover and the negative-electrode bus bar assembly, and a bottom surface of the unit electric power storage portion includes a safety valve exposed to the third exhaust passage.

7. The electric power storage device according to claim 1, wherein
the cover member includes a side surface facing the first exhaust port, the side surface include a hole portion that is open to the first exhaust port, the hole portion includes a bottom portion at a position entering the cover member from the side surface, and the bottom portion includes a film portion configured to be melted by the gas discharged from the unit electric power storage portion.
